(19) United States
(12) Patent Application Publication
(10) Pub. No.: US 2008/0309252 A1
(43) Pub. Date: Dec. 18, 2008

(54) Controller of Light Dimmig and Overload Protection

(75) Inventors: Ye Guanrong, Zhejiang (CN); Ye Guanlin, Zhejiang (CN); Chou Shih Biry, Taipei (TW)

Correspondence Address: LIEBERMAN & BRANDSDORFER, LLC, 802 STILL CREEK LANE, GAITHERSBURG, MD, 20878, US

(73) Assignee: Canel Lighting Co. Ltd.

(21) Appl. No.: 11/764,245

(22) Filed: Jun. 18, 2007

(51) Int. Cl. H05B 41/36; H02H 3/00

(52) U.S. Cl. 315/291; 361/1

(57) ABSTRACT

The dimmer controller cart be installed within the structure of a light fixture or freestanding lamp, alternatively the circuit can be installed in a cord. The circuit includes a power shaping circuit for control of the incoming AC power which is then sent through a variable control dimmer to vary the power to the lamp. The wattage through the lamp is monitored and the monitored wattage is sent as an input to the a control IC which uses an outout to control the voltage to the lamp as an overload protection. The circuit is used to control the wattage supplied to & lamp from a minimum non-activating wattage to a maximum a maximum wattage which can for example be 190 W. When the current reaches the maximum wattage, for example 190 W, then the light will exceed protection overload and the circuit will re-start.

### BACKGROUND OF THE INVENTION

The present invention relates to controls for lamps, including dimming control and overload protection for a light. More particularly, the present invention relates to the use of a circuit placed between the current source and a light for dimming control of the light and to protect the light against overload.

This invention concerns a controller for overload protection which will satisfy the IEC standard. The traditional protection controller can not be used as a dimmer to control the power to the light. Traditional protection controllers can not be as a dimmers to control a light, although prior art dimmers can control the power to a light, because of electronic interference caused by such dimmers, they can not attain the IEC standard to connect to power nets. If a conventional overload protection controller is used for dimming, the dimmer will not attain the IEC standard for connection to power nets because of the electronic disturbance.

The controller taught in the present invention provides overload protection and completely satisfies the requirements of (CISPR. 15, EN55015) for restraining electronic disturbance of IEC in comparison with traditional techniques.

### SUMMARY OF THE INVENTION

The dimmer controller can be installed within the structure of a light fixture or freestanding lamp, alternatively the circuit can be installed in a cord. The circuit includes a power shaping circuit for control of the incoming AC power which is then sent through a variable control dimmer to vary the power to the lamp. The wattage through the lamp is monitored and the monitored wattage is sent as an input to the a control IC which uses an outout to control the voltage to the lamp as an overload protection. The circuit is used to control the wattage supplied to a lamp from a minimum non-activating wattage to a maximum a maximum wattage which can for example be 190 W. When the current reaches the maximum wattage, for example 190 W, then the light will exceed protection overload and the circuit will re-start.

### BRIEF DESCRIPTION OF THE DRAWINGS

For a better understanding of the nature of the present invention, reference is had to the following figures and detailed description, wherein like elements are accorded like reference numerals, and wherein:

FIG. 1 is a circuit diagram of the present invention.

FIG. 2 illustrates an embodiment of the present invention configured for installation as an in-stem light control.

FIG. 3 illustrates an embodiment of the present invention configured for installation as an in-line light control.

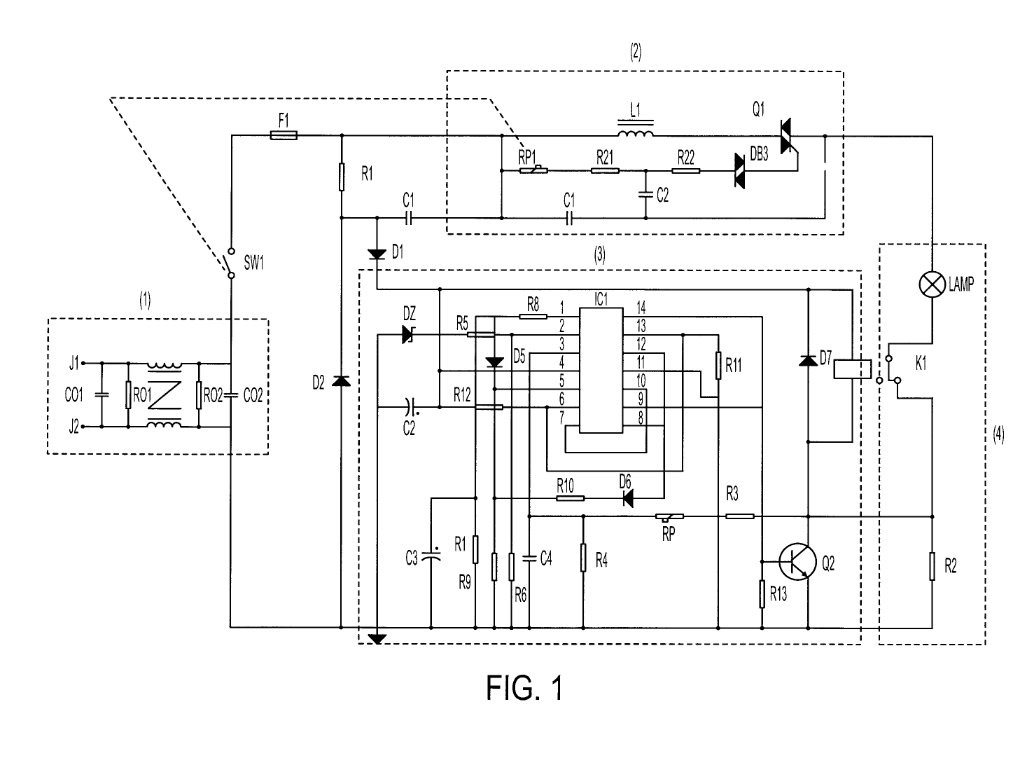

### DETAILED DESCRIPTION OF PREFERRED EXEMPLARY EMBODIMENTS

The system consists of 4 parts, an EMC filtering circuit which is connected to line current. A dimmer circuit used to vary the amount of current passed through to the light. An overload protection circuit to comply with electrical standards and to avoid an overload condition. A load, the light which is supplied by the circuit.

The EMC filtering circuit (1) consists of two capacitors C01 and C02 as well as R01 and R02. The EMF filter also utilizes a common mode inductance L1 to restrain the conducting disturbance. The configuration of the EMF filtering circuit allows the performance of the conducting disturbance to attain the appropriate requirement (CISPR 15,EN55015) of electronic disturbance of the IEC. AC power applied to J1 and J2 is transferred from the EMC circuit portion (1) on one side directly to the light through sampling resister R2 and on the other side to the dimmer circuit (2).

The Dimmer portion (2) of the circuit includes capacitors C1, C2 and resistors R21 and R22, loop L1, and transistor Q1, as well as diode DB3 and variable resistor/potentiometer RP1. Adjusting the variable resistor RP1 changes the output voltage of Q1 to control the power of load. Voltage to the Lamp is supplied through Q1 while normally closed relay K1 maintains its closed state, which is controlled by Q2.

Overload protection circuit portion (3) consists of the IC and C2, C3, C4, R5, R6, D5 and D6. The voltage of sampling resistor R2 will be transferred to Pin No. 3 of IC 1, through R3 and variable resistor RP1. The voltage level on R2 is detected within. IC 1 and a feedback signal will be output from Pin No. 14 of IC 1. When the voltage of R2 is higher than a set value, Pin No. 14 of IC 1 will output a positive voltage to control the switching transistor Q2 to control the relay to switch off the power supply of load, thus, it will protect the load from overloaded.

Load circuit (4) consists of light source, normally closed contact relay K1 and sampling resistor R2. If the protection circuit of the overload works, the power supply of light source will be switched off to avoid overload and be protected.

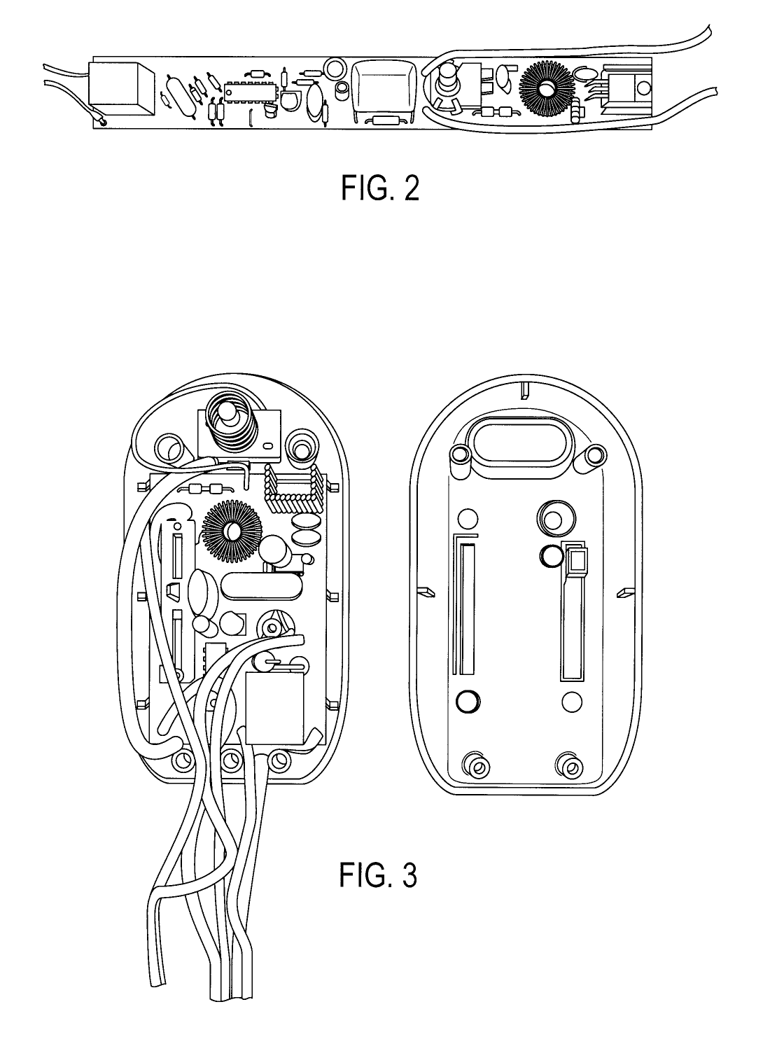

In the configuration of the embodiment of the present invention illustrated in FIG. 2, the components of the circuit of present invention are arranged on a circuit board configured to fit within the hollow interior of a torchiere stem tube. The stem of potentiometer RP1 extends through the side wall of the stem for control of the lamp. The potentiometer RP1 is a rotation switch with an initial on-off position and a variable resistance over the remainder of the rotation.

In the configuration of the embodiment of the present invention illustrated in FIG. 3, the components of the circuit of present invention are arranged on a circuit board configured to fit within an enclosure separate from the lamp. The potentiometer RP1 can be implemented as a rotating switch as illustrated in FIG. 2 for hand operation or as a slider and separate on-off switch as illustrated in FIG. 3. The embodiment illustrated in FIG. 3 can be operated as a foot switch or hand operated.

Because many varying and different embodiments may be made within the scope of the inventive concept herein taught, and because many modifications may be made in the embodiments herein detailed in accordance with the descriptive requirements of the law, it is to be understood that the details herein are to be interpreted as illustrative and not in a limiting sense.

1. A dimmer control and overload protection circuit for a light, comprising:
a first input power conditioning portion of said circuit having inputs for AC power and output for conditioned alternating current;
a dimmer portion of said circuit connected to said output of said input power conditioning circuit portion for receipt of said conditioned alternating current;
a load portion of said circuit for connection to said light and having a control switch and a power monitoring component; and
an overload protection portion of said circuit connected to said monitoring component and connected to said control switch.

2. A dimmer control and overload protection circuit, according to claim 1,
said input power conditioning circuit further comprising:
an EMC filter.

3. The dimmer control and overload protection circuit, according to claim 1, wherein:
said dimmer portion of said circuit places a variable resistance to current flow between said output of input power conditioning circuit portion and said load portion of said circuit to control the quantity of power supplied to said light to adjust the optical intensity of said light.

4. The dimmer control and overload protection circuit, according to claim 1, wherein:
said overload protection portion of said circuit is used to protect the load by control of a load interrupt relay to switch off the power supply when overload is detected.

5. The dimmer control and overload protection circuit, according to claim 1, wherein:
said power monitoring component includes a sampling resistor to sample the power as applied to said light; and
said overload protection portion of said circuit includes a control component to monitor said sampling resister and to provide a control signal to said control switch to terminate power to said lamp for overload protection.

6. The dimmer control and overload protection circuit of claim 5, wherein:
said control component includes an integrated circuit having an input for monitoring of said sampling resister and an output for providing said control signal wherein said integrated circuit provides said control signal when the level of said monitored input exceeds a predetermined threshold level.

7. A dimmer control and overload protection for a light, comprising:
a first input power conditioning circuit having an input for AC power and an output for conditioned alternating current;
a dimmer circuit including a variable resister connected to said output of said input power conditioning circuit for receipt of said conditioned alternating current;
a load circuit including a light and having a control switch and a sampling resistor to sample the power as applied to said light; and
an overload protection and control circuit having a control component connected to said sampling resister to monitor the power level of said sampling resister and connected to said control switch to provide a control signal to said control switch to terminate power to said lamp for overload protection when the sample level of said sampling resister exceed a predetermined threshold level.
